(19) United States
(12) Patent Application Publication
(10) Pub. No.: US 2024/0240510 A1
(43) Pub. Date: Jul. 18, 2024

(54) DOOR SYSTEM

(71) Applicant: Kingsway Enterprises (UK) Limited, Swanley (GB)

(72) Inventors: Benjamin Hall, Swanley (GB); Melvyn French, Swanley (GB)

(21) Appl. No.: 18/411,384

(22) Filed: Jan. 12, 2024

(30) Foreign Application Priority Data
Jan. 12, 2023 (GB) 2300492.2

(51) Int. Cl. E06B 5/00; E06B 1/20; E06B 1/52

(52) U.S. Cl. CPC E06B 5/00; E06B 1/20; E06B 1/52

(57) ABSTRACT

A door system for fitting to a wall is disclosed, the door system comprising a first frame portion and a second frame portion to which a door leaf is attached, wherein the door leaf comprises an anti-ligature device. The second frame portion is configured to slidingly engage with the first frame portion between first and second limit positions such that the door system can accommodate a variety of wall thicknesses.

### RELATED APPLICATION

This application claims priority to Great Britain Patent Application No. 2300492.2, filed Jan. 12, 2023, the disclosure of which is incorporated herein by reference.

### TECHNICAL FIELD

The present disclosure relates to a door system for fitting to a wall. In particular, the present disclosure provides a door system for use in settings where doors contain anti-ligature devices.

### BACKGROUND

In psychiatric hospitals and prisons, a problem exists that patients and inmates may wish to cause themselves harm using a ligature created by securing a rope or cable around an available anchor point in a room. One solution to this problem is to design room fixtures and fittings such that they do not provide such anchor points. However, in some cases this is difficult or impossible. An example of this is door fittings. Individuals may try to create a ligature by securing a rope or cable around a door handle or other hardware associated with the door such as a door hinge, or around an edge of the door leaf itself.

One way of mitigating this issue is to attach anti-ligature devices to the door to prevent and/or detect ligature attachment. One example of such an anti-ligature device is a ligature-detection sensor, which is typically provided in the form of a switch and can be attached to an edge (e.g. top edge) of a door leaf. When a ligature is secured around the device and pressure is applied, the switch is caused to close, thereby completing or breaking an electrical circuit and activating an alarm. Accordingly, while the door leaf may itself remain a potential ligature hazard, safety is nonetheless improved because a nearby prison officer or healthcare professional is alerted when an individual attempts to secure a ligature around the door leaf. Other anti-ligature devices, such as specially designed handles or hinges, may be provided to make it more difficult to attach a ligature to other parts of the door.

A problem exists, however, in that doors fitted with such specialist anti-ligature hardware need to be fitted very carefully and precisely within their door frames to ensure correct functioning of the anti-ligature mechanisms. Badly fitted doors may result in suboptimal functioning of the anti-ligature devices, putting patient or inmate safety at risk. For example, if a gap between a door edge and the doorframe is too small, then a ligature-detection sensor provided along the door edge may become damaged or malfunction, for example through frequent false alarms triggered as the door edge comes into contact with the frame. Potentially even more problematic is the case where the gap between the door edge and the door frame is too large. A large gap could enable a ligature to be jammed or otherwise anchored into the gap. Additionally, if the gap is sufficiently large, a ligature secured to the door frame within the gap may not be registered by the ligature-detection sensor on the door leaf. In the case of an anti-ligature hinge, misalignment within the door frame may again provide a gap or crevice into which a ligature could be anchored. As can be seen, therefore, an ill-fitting door leaf or door frame can significantly increase the risk of a ligature attachment taking place or going unnoticed, which has serious negative implications for patient and inmate safety. There is also a problem that doors, frames and anti-ligature devices may easily become damaged during assembly and fitting of the door, in particular when the door is hung in the frame. Damage to an anti-ligature device on the door may not be immediately identified during fitting, meaning that ligature-detection or prevention may be compromised in a patient's room for an extended period of time. This obviously represents a significant and undesirable patient safety risk.

The above-described problems are exacerbated by the fact that members of construction staff who are fitting doors during building or renovation work are often not sufficiently skilled or well-trained to recognise when a door comprising anti-ligature features is correctly fitted or if an anti-ligature device has been damaged. Regular (e.g. domestic or workplace) doors have much broader tolerances than anti-ligature doors, and a gap, misalignment or other defect which may be perfectly acceptable in a domestic or office setting may prove a safety hazard in a psychiatric ward or prison. Often, construction staff are entirely unaware of these considerations, however. Further, even if construction staff are aware of the fitting requirements, workers may mis-fit a door or damage an anti-ligature device due to simple human error.

As can be seen, existing doors, door frames, and methods of installing doors in settings such as psychiatric wards suffer from significant drawbacks which can ultimately endanger patients, inmates and any other occupants of rooms where such door systems are fitted. It would be advantageous to provide systems and methods which address one or more of the above-described problems, in isolation or in combination.

### OVERVIEW

This overview introduces concepts that are described in more detail in the detailed description. It should not be used to identify essential features of the claimed subject matter, nor to limit the scope of the claimed subject matter.

According to one aspect of the present disclosure, there is provided a door system for fitting to a wall. The door system comprises a first frame portion and a second frame portion and may therefore be considered a two-part door frame. A door leaf comprising an anti-ligature device is attached to the second frame portion. The second frame portion is configured to slidingly engage with the first frame portion between first and second limit positions, such that the door system can accommodate a variety of wall thicknesses.

This arrangement is beneficial because the entire door leaf and frame assembly can be provided as a prefabricated set, ready to be installed. This means that neither frame portion needs to be constructed on site by potentially unskilled or insufficiently trained construction workers. Also, it can be ensured that the corners of the first and second frame portion are both adequately square and that the first and second frame portions are therefore correctly sized to slidingly engage with one another. In this context, “slidingly” means that the first and second frame portions can be brought into engagement with one another at a first position and can then slide relative to one another whilst remaining in engagement, between said first position and a different, second position. The position at which the engaged frame portions are engaged and at their maximal separation is referred to as a “first limit position” herein. Similarly, the position at which the engaged frame portions are engaged and at their minimal separation is referred to as a “second limit position” herein. These positions are illustrated more fully in the below figures. The labels “first” and “second” are provided simply to differentiate the limit positions and do not imply any absolute ordering.

By providing the frame portions as a prefabricated set in this manner, fitting is simplified. Because it is possible to ensure ahead of time that there will be a perfect fit between the two frame portions, they can be engaged simply and easily at fitting time by sliding into place, with minimal risk of damage to the frame or door leaf in the process. The sliding engagement means the frame portions can fit a range of wall thicknesses with ease and without any impact on or required reconfiguration of the anti-ligature device(s) on the door leaf.

Most importantly, because the second frame portion already comprises the door (i.e. the door is pre-hung in the second frame portion prior to fitting time) both frame portions can be pre-manufactured to fit perfectly into one another and around the door leaf. As a result, a good fitting of the frame and door leaf that is within required quality control tolerances (e.g. in terms of squareness of edges and gap size) can be achieved without needing to rely on the skill of construction workers on-site. Prefabrication of the components means fitting and tolerances can instead be checked and signed off at a factory or quality control centre prior to shipping. This high degree of quality control is very important in the field of anti-ligature doors because, as explained above, it is imperative that the fit between frame and door leaf is good and within tight tolerances to ensure proper functioning of the anti-ligature device(s) and resulting safety for patients. The fact that the door leaf is pre-hung within the second frame portion also advantageously reduces risk of damaging the door leaf or any associated anti-ligature devices, because an additional step of positioning and hanging the door leaf within the frame on-site (which is when damage most frequently occurs) is not needed.

The anti-ligature device comprised by the door leaf may comprise at least one of a ligature-detection sensor, an anti-ligature hinge, an anti-ligature door handle, and a sloped door leaf edge. In other words, the anti-ligature device may be preventative (as in the case of the hinge, handle, and sloped edge) in that it makes it more difficult to attach a ligature to the door. Alternatively, the anti-ligature device may be curative (as in the case of the ligature-detection sensor) in that it makes it easier to detect when a ligature has been attached to the door. Other example anti-ligature devices will be apparent to a skilled reader, and any combination of curative and/or preventative anti-ligature devices can be included in the door leaf of the present disclosure. These devices greatly improve the safety of persons in settings where self-harm may be attempted, such as psychiatric wards and prisons.

In examples where the anti-ligature device comprises a sloped door leaf edge, the sloped door leaf edge may be the top edge of the door leaf. This makes it more difficult to attach a ligature to the top edge of the door leaf, because pressure applied to the other end of the ligature will cause the ligature to slide down and fall off the door leaf. This is advantageous because the top edge of a door leaf is the most likely edge where ligatures may be attached.

In examples where the anti-ligature device comprises an anti-ligature door handle, the anti-ligature door handle may have a continuously sloped profile that is free of ligature anchor points. In other words, all surfaces of the handle may be substantially curved. This can provide a handle that is free from any hard edges, lips, ledges, crevices or protrusions into or around which a ligature could be fastened or anchored.

In some implementations, the first frame portion may comprise a first support element configured to provide a contact point between the first frame portion and a wall to which the first frame portion is affixed. This support element advantageously provides structural support to the first frame portion, as well as an additional contact point where shims or other packing can be provided to ensure a good fit between the first frame portion and the wall. Providing structural support and an additional contact point with the wall in this manner is very beneficial in the context of anti-ligature doors. Such doors are generally much heavier than domestic doors, due to the inclusion of anti-ligature devices and the need for the doors to be robust to withstand potential patient/inmate abuse. To be able to hold such heavy doors, the fixings means (e.g., screws) used to attach the frame portions to the wall and one another need to be large and strong. Due to the weight of the door and these heavy-duty fixing means, significant twisting and pulling forces are often applied to the door frame during attachment to the wall. Providing the above-described support element helps the first frame portion withstand these forces, which can prevent warping or bending of the first frame portion. Providing an additional contact point also makes it easier to adapt the frame portion to an uneven wall surface, because an additional point where packing and shims can be placed is provided.

In some implementations, the first support element defines a closed cross-sectional area with respect to the first frame portion. In other words, in combination the support element and frame portion provide an enclosed, cross-sectional area. Such a closed cross-sectional area advantageously provides improved structural support compared to more open support structures, which are less stable and are therefore vulnerable to twisting and pulling forces. The benefits of closed structures compared to open structures will be explained more fully below.

In some implementations, the first support element comprises two supporting limbs configured to abut the first frame portion, and an intermediate limb coupling the two supporting limbs. This arrangement provides a substantially “u-shaped” structure, with two vertical supporting limbs and one horizontal coupling limb holding the vertical limbs together. It will be appreciated that the terms “vertical” and “horizontal” are relative terms intended merely to aid understanding of the shape of the support element. These terms do not imply any absolute orientation in use. This shape advantageously provides a particularly effective and stable support structure for supporting the first frame portion. The limbs of the first support element may be integral with one another, in other words the support element can be manufactured as a single piece.

In some implementations, the second frame portion comprises a second support element configured to provide a contact point between the second frame portion and a wall. The second support element provides the same advantageous benefits as the above-described first support element, except now with respect to the second frame portion. In particular, additional support is provided to the second frame portion to resist twisting and bending forces, and an additional contact point between the second frame portion and wall is provided to enable easier and more secure attachment to the wall.

In some implementations, the second frame portion may advantageously comprise a third support element configured to provide a contact point between the first frame portion and the second frame portion. The benefits of this third support element are as for the first and second support elements, except in that the third support element provides support at the interface between the first and second frame portions. This again improves rigidity and avoids bending or warping during fixing, for example when the frame portions are fastened together or are respectively fastened to the wall.

As in the case of the first support element, the second and/or third support element may define a closed cross-sectional area with respect to the second frame portion. At least one of the second or third support elements may comprise two supporting limbs configured to abut the second frame portion, and an intermediate limb coupling the two supporting limbs. The benefits of these particular arrangements and structures are as described above in relation to the first support element.

It will be appreciated that the first, second and third support elements provide complimentary and synergistic effects in that they all help to support and provide rigidity to the frame as a whole. The first and second support elements in particular both provide additional contact points between the frame as a whole and the wall, which makes the entire assembly particularly strong and adaptable to uneven wall surfaces. That said, it will of course be appreciated that the first, second and third elements can be provided independently. That is, while they combine to provide a synergistic technical effect, there is nevertheless no inextricable structural or functional link between these elements. One of the support elements may therefore be provided in the absence of the other two, and indeed any combination of the first, second and third support elements may be provided. Any number (including none) of the first, second and third support elements may be provided. It will be appreciated that the terms “first”, “second” and “third” are merely labels to differentiate between the functions of the various support elements, and do not imply any absolute ordering or placement.

Advantageously, the door leaf, when in the closed position, may be free of ligature anchor points. In other words, once the door is closed it can be free of any hard edges, lips, ledges, crevices or protrusions into or around which a ligature could be fastened. This ensures patient and inmate safety.

In some implementations, the second frame portion may comprise a fin configured to contact the door leaf when the door leaf is in the closed position, wherein the fin is made from a flexible material. The fin provides an alternative abutment point for an edge of the door, which may be particularly suitable for an internal door in a patient or inmate's room, such as a shower door. Because the fin is flexible, it is difficult to attach a ligament to the fin. This enables an interior door such as a shower door to be provided which looks, feels and functions like an interior door whilst still being ligature-safe.

According to another aspect of the present disclosure, there is provided a method of fitting a door system to a wall. The method comprises securing a first frame portion to a wall and engaging the first frame portion with a second frame portion. A door leaf comprising an anti-ligature device is attached to the second frame portion and the second frame portion is configured to slidingly engage with the first frame portion between first and second limit positions. The method further comprises moving the second frame portion to a position between the first and second limit positions, such that the first and second frame portions abut respective faces of the wall, and securing the second frame portion to the wall. The phrase “between the first and second limit positions” is to be interpreted inclusively, in the sense that it includes the first and second limit positions.

The disclosed method provides an advantageous process for fitting an anti-ligature door leaf and accompanying door frame to a wall. In particular, as noted above, the frame portions and door leaf can be prefabricated prior to fitting, to ensure a good fit that is within the required tolerances to ensure patient safety. The first portion can be fitted to the wall and, once fitted, provides a ready-made opening into which the second frame portion can be slid. As noted above, the first and second frame portions are configured to slidingly engage between limit positions, such that the frame as a whole can be easily fitted to a wall having any thickness between the minimal and maximal separation of the frame portions defined by the respective limit positions. As noted above, because the door leaf is pre-hung in the second frame portion, no additional step of hanging the door leaf is required. This is very beneficial, because anti-ligature doors (i.e. doors containing one or more anti-ligature devices as described herein) are very sensitive and can be easily damaged during hanging of the door leaf. By providing prefabricated frame portions with the door leaf already pre-hung in the second portion, this is avoided. In particular, the risk of denting or damaging any of the anti-ligature devices comprised by the door leaf (or frame) is reduced. A perfect fit between the door and frame can be easily achieved without requiring any particular skill from the on-site construction workers, because the door has already been fitted to the second frame portion previously, prior to fitting time. For example, a consistent gap between the door leaf and second frame portion that is between 2 mm and 4 mm can be ensured, which ensures correct functioning of any ligature-detection device attached to the door leaf.

The construction worker on-site thus only needs to fit the first frame portion and then slide the second portion into the first. This method provides a striking contrast to existing fitting methods which generally involve building a single-piece frame into a wall from scratch and then hanging the door leaf in the frame in a subsequent step. As noted in the introduction above, this traditional fitting method is ill-suited to fitting doors that contain sensitive anti-ligature devices and which have very tight tolerances in terms of acceptable fitting parameters (door-frame gap, hinge-frame gap, hinge-door gap etc.). The disclosed methods overcomes these problems and provides a more reliable method for fitting an anti-ligature door which increases patient safety.

The frame portions and door leaf utilised in the disclosed methods may comprise any combination of the anti-ligature or support features described herein. As described above, the anti-ligature device may comprise at least one of a ligature-detection sensor, an anti-ligature hinge, an anti-ligature door handle, and a sloped door leaf edge. In examples where the anti-ligature device comprises a sloped door leaf edge, the sloped door leaf edge may be the top edge of the door leaf. In examples where the anti-ligature device comprises an anti-ligature door handle, the anti-ligature door handle may have a continuously sloped profile that is free of ligature anchor points. In some examples, the door leaf, when in the closed position, may be free of ligature anchor points. In some examples, the second frame portion may comprise a fin configured to contact the door leaf when the door leaf is in the closed position, wherein the fin is made from a flexible material. The benefits of these various example arrangements are as described above.

According to another aspect of the present disclosure, there is provided a door system for fitting to a wall. The door system comprises a first frame portion, wherein the first frame portion comprises a first support element configured to provide a contact point between the first frame portion and a wall. The door system further comprises a second frame portion, wherein the second frame portion comprises: a second support element configured to provide a contact point between the second frame portion and a wall; and a third support element configured to provide a contact point between the first frame portion and the second frame portion. The second frame portion is configured to slidingly engage with the first frame portion between first and second limit positions such that the door system can accommodate a variety of wall thicknesses.

This door system provides a particularly robust and rigid door-frame assembly. The first and second support elements provide additional support and contact points between the frame portions and the wall. The third support element provides support at the interface between the frame portions. The benefits of this construction are as described above.

According to yet another aspect of the present disclosure, there is provided a method of fitting a door system to a wall. The method comprises securing a first frame portion to a wall, wherein the first frame portion comprises a first support element configured to provide a contact point between the first frame portion and the wall. The method further comprises engaging the first frame portion with a second frame portion, wherein the second frame portion is configured to slidingly engage with the first frame portion between first and second limit positions. The second frame portion comprises: a second support element configured to provide a contact point between the second frame portion and the wall; and a third support element configured to provide a contact point between the first frame portion and the second frame portion. The method further comprises moving the second frame portion to a position between the first and second limit positions such that the first and second frame portions abut respective faces of the wall and securing the second frame portion to the wall. The first, second, and/or third support elements may have the structure and associated benefits described above.

This method provides similar benefits to the method described above. In particular, a reliable method for attaching a door frame to a wall which provides a robust attachment and increased stability is provided. The door frame is well suited to holding anti-ligature doors, due to the various support elements included in the frame. The frame portions can easily adapt to a variety of wall thickness due to their two-part nature and sliding engagement.

### BRIEF DESCRIPTION OF THE FIGURES

Illustrative implementations of the present disclosure will now be described, by way of example only, with reference to the drawings. In the drawings:

FIGS. 1A-1G show a number of views of a first example door system according to the present disclosure;

FIG. 2 shows a method of fitting a door system according to the present disclosure;

FIGS. 3A and 3B show cross-sectional views of example support elements which may be incorporated into the door systems of the present disclosure;

FIGS. 4A-4L show a number of views of a second example door system according to the present disclosure;

FIGS. 5A-5L show a number of views of a third example door system according to the present disclosure;

FIG. 6 shows an example ligature-detection sensor according to the present disclosure provided on a door leaf edge; and

FIGS. 7A-7C indicate various possible positions of the ligature-detection sensor of FIG. 6.

Throughout the description and the drawings, like reference numerals refer to like features.

### DETAILED DESCRIPTION

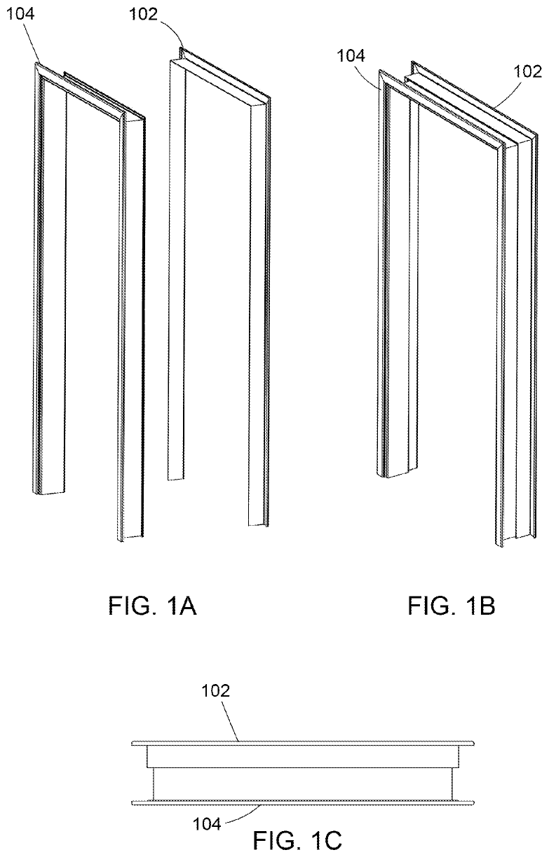

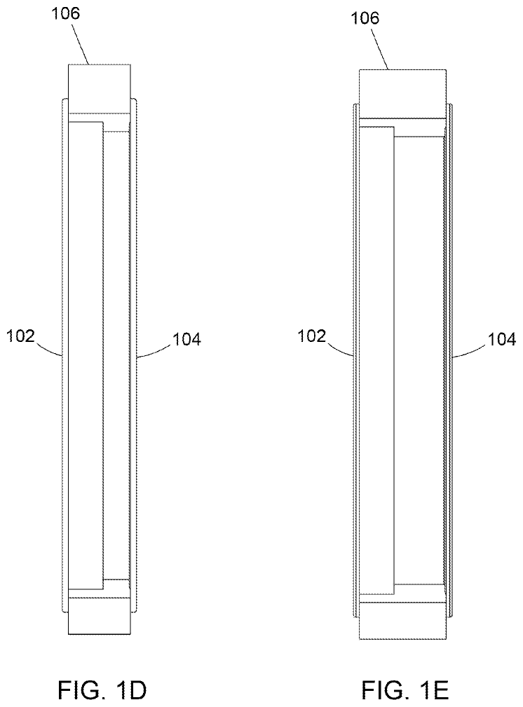

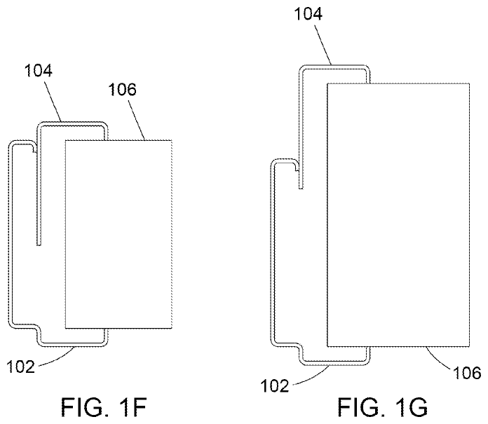

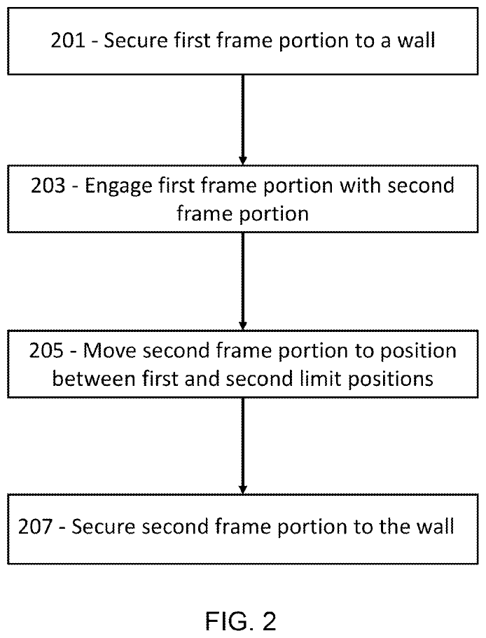

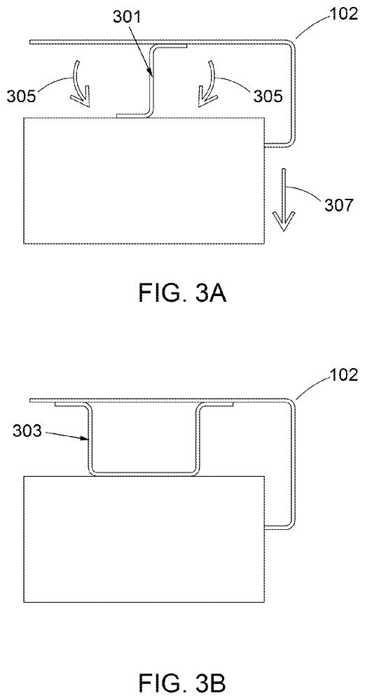

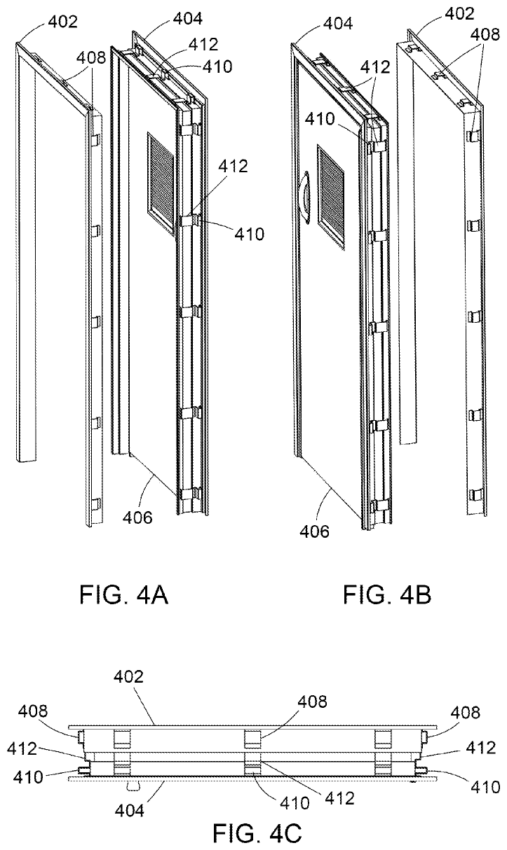

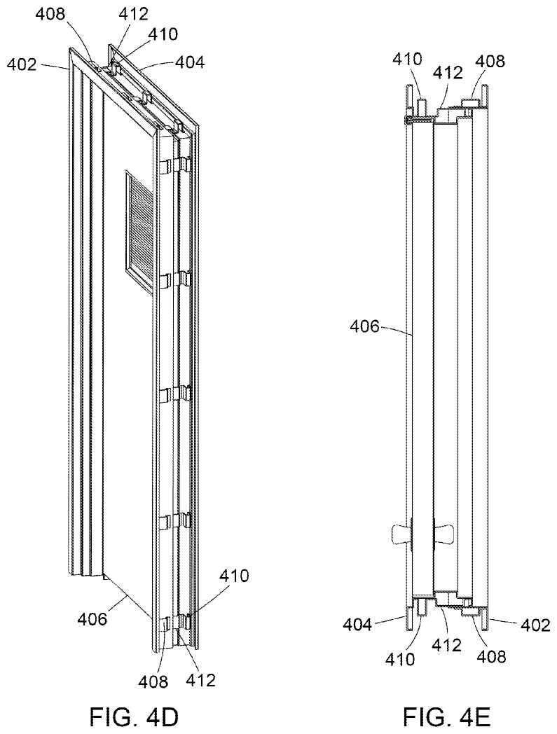

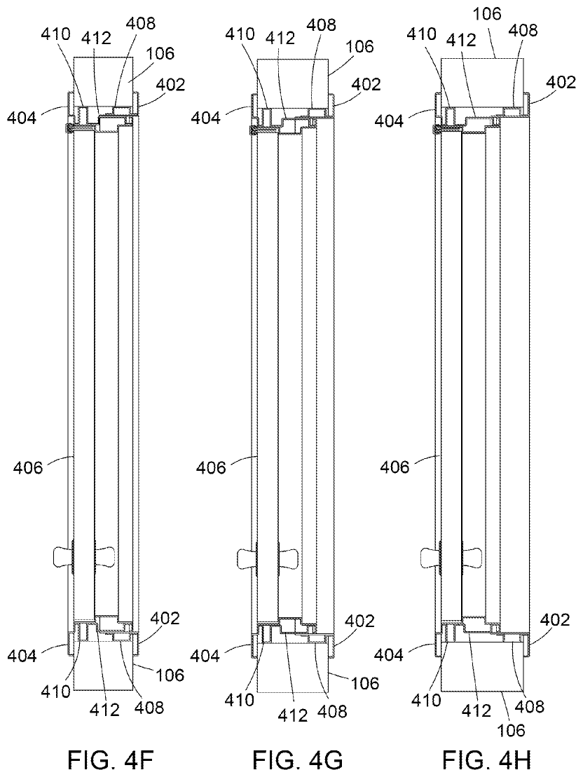

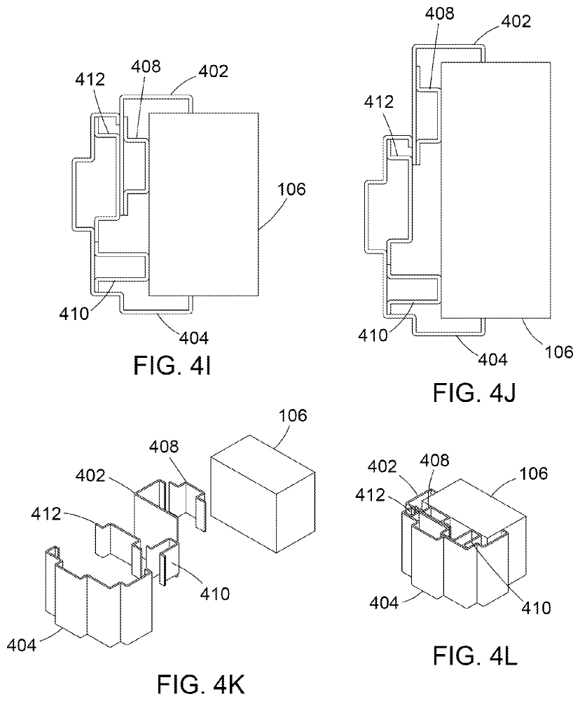

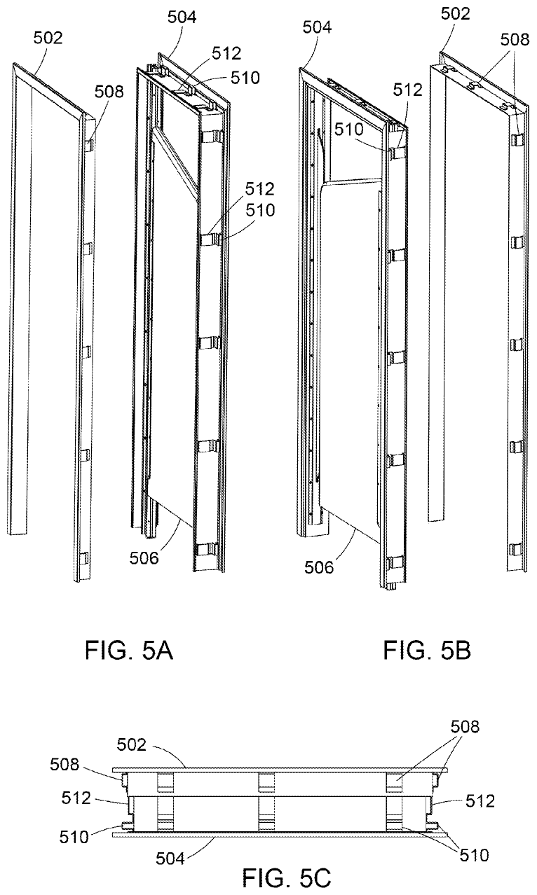

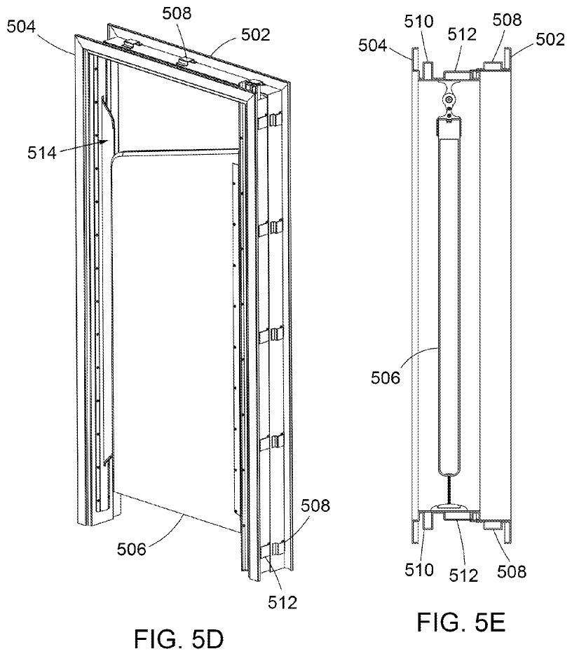

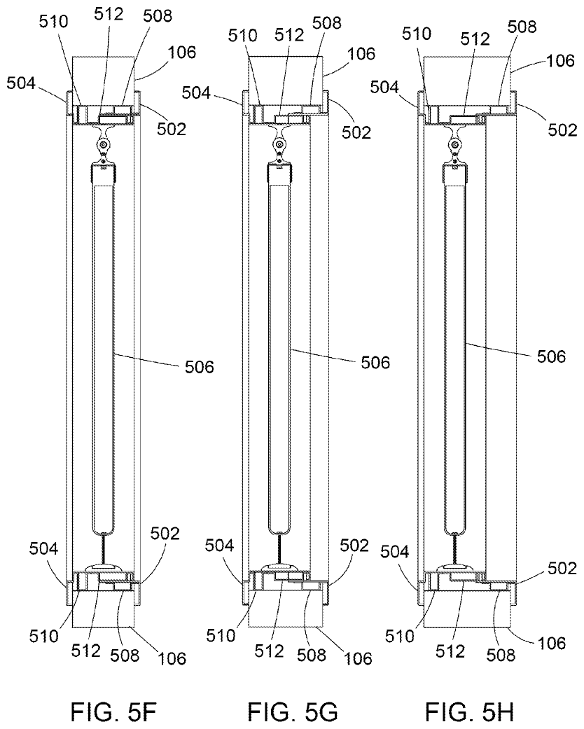

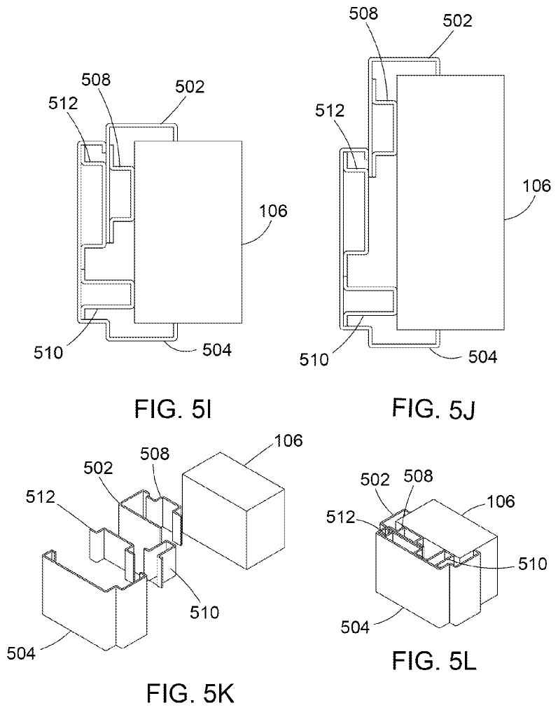

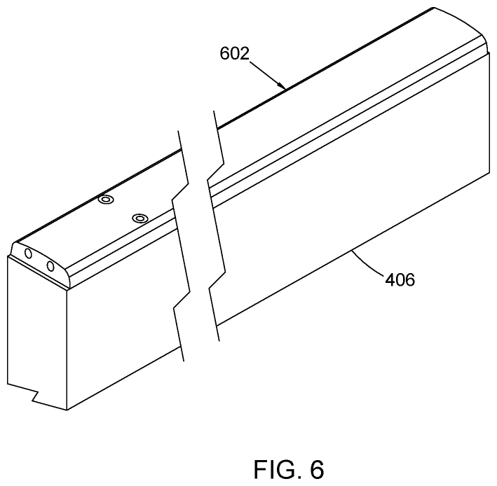

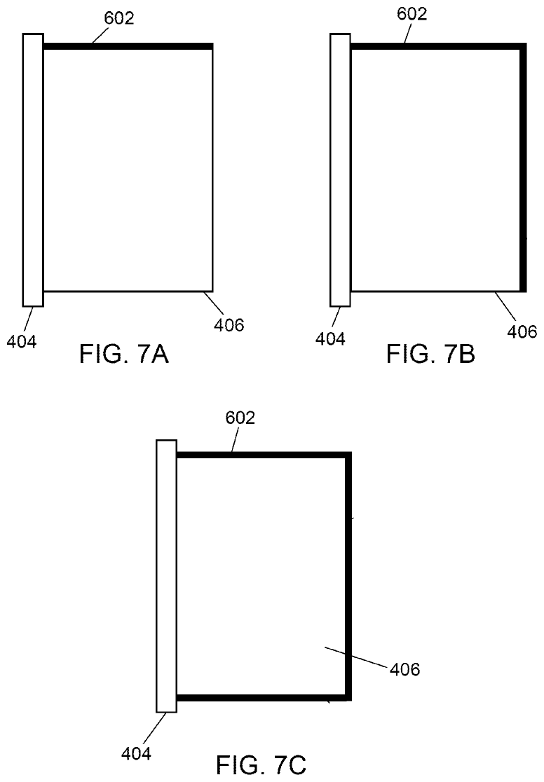

This detailed description describes, with reference to FIGS. 1A-1G, an example door system according to the present disclosure. A method of fitting such a door system is described with reference to FIG. 2. Support elements which may be incorporated into the door system to provide support and rigidity are described with reference to FIGS. 3A and 3B. Alterative example door systems comprising different anti-ligature devices and door leaves are described with reference to FIGS. 4A-4L and 5A-5L respectively. Finally, ligature-detection sensors are described in more detail with reference to FIGS. 6 and 7A-7C.

The devices and methods disclosed herein relate generally to fitting of a door leaf and door frame to a wall. The disclosed devices and methods are particularly well adapted for use in psychiatric wards and prisons. As described in the introduction above, existing devices and methods for this purpose suffer from various problems in settings where patient or inmate self-harm is a risk. In particular, existing door frames and door leaves are prone to damage, misalignment and general poor fitting. As a result, existing systems and methods are overly reliant on highly skilled construction workers being able to appropriately fit the frames and door leaves. Even well-trained construction workers may, however, mis-fit or damage these components due to simple human error.

The disclosed systems and methods address these problems by providing a two-part door frame and associated fitting method. In certain advantageous implementations, one portion of the door frame comprises a door leaf that is already pre-hung within the frame portion. This two-part door frame (and pre-hung door, if present) are referred to as a “door system” herein. As noted above, the door system comprises two frame portions which are configured to engage with one another in a simple, sliding engagement. The sliding engagement means the frame can be easily fitted to a variety of wall widths at fitting time, meaning the wall width does not need to be known ahead of time and the frame structure itself does not need to be modified depending on the wall thickness. The frame portions can advantageously be prefabricated for a perfect fit and squareness at a factory prior to shipping. Further, in certain advantageous implementations, a door leaf comprising one or more anti-ligature devices is pre-hung in one of the frame portions. This means that a separate step to hang the door on-site at fitting time is not required, significantly reducing the likelihood that a door leaf, frame or anti-ligature device is badly fitted, misaligned, or damaged.

Turning first to FIGS. 1A-1G, a number of views of a first example door system according to the present disclosure are shown. Starting with FIG. 1A, the door system as shown comprises a first frame portion 102. As can be seen, in the example shown the first frame portion 102 comprises a standard-shaped rectangular frame including three edges—two side edges and a top edge. The bottom of the frame portion 102 is open for interfacing with the floor in this example. The door system also comprises a second frame portion 104. The second frame portion 104 has the same three-sided construction as the first frame portion 102. Each frame portion in this example includes a flange on all three sides, which provides a surface for abutment to opposite respective room-facing sides of a wall. The first frame portion 102 and second frame portion 104 are constructed such that they can slidingly engage with one another. This enables the door system to adapt to fit the width of the wall at fitting time. FIGS. 1B and 1C show the second frame portion 104 engaged with the first frame portion 102 in this manner.

In the example shown, the first frame portion 102 is very slightly (approximately 1 mm) larger than the second frame portion 104, such that the second frame portion 104 can be slid into and be received by the first frame portion 102 with a snug fit. In other examples, the second frame portion 104 may be the larger and receive the first frame portion 102 in the same manner.

This sliding engagement is permitted between maximal and minimal separations, which are each defined by respective limit positions of the frame portions. In other words, a first limit position is defined as the position which provides the greatest separation between the room-facing edges of the first frame portion 102 and second frame portion 104 that can be achieved whilst still securing the frame portions together in use. In other words, the first limit position is the position at which the gap between the frame portions into which a wall can fit is at its widest. In an example, the separation between the room-facing edges of the frames at the first limit position may be between 170 mm and 190 mm. In one particular example, the separation at the first limit position is 178 mm, which is the thickest wall width commonly used for internal walls.

Conversely, a second limit position is defined as the position which provides the smallest separation between the room-facing edges of the first frame portion 102 and second frame portion 104 that can be achieved whilst still securing the frame portions together in use. In other words, the second limit position is the position at which the gap between the frame portions into which a wall can fit is at its narrowest. In an example, the separation between the room-facing edges of the frames at the second limit position may be between 120 mm and 140 mm. In one particular example, the separation at the second limit position is 127 mm, which is the thinnest wall width commonly used for internal walls.

From the above examples, it can be seen that the disclosed door system is particularly advantageous when the first and second limit positions are configured such that the door system is able to adapt to a wall thickness of between 120 mm and 190 mm, more preferably 127 mm and 178 mm. That said, the exact minimum and maximum separation at the first and second limit positions will of course depend on the particular dimensions of the frame portions and the fixing means used to fix the frame portions together in use, which will vary according to manufacturing contexts and requirements. The key point is that the sliding engagement between the frame portions means that the frame can be adapted at fitting time to fit any width of wall between the first and second limit positions inclusive, and no structural adaptations to the frame need to be made to achieve this—the frame simply slides to the correct width. This functionality is shown more clearly in FIGS. 1D-1G.

FIG. 1D shows the door system in plan view from above, fitted to a wall 106 which is shown at either end of the door system in cross-section for ease of understanding. The second frame portion 104 is slidingly received within the first frame portion 102 in the manner described above with reference to FIGS. 1A-C. Flanges of both frame portions abut respective and opposing room-facing sides of the wall 106, permitting each frame portion to be fixed to the wall 106 with suitable fastening means. Because the wall 106 in FIG. 1D is quite thin, the frame portions are positioned at or near their minimal separation, i.e. at or near the second limit position of the door system. Accordingly, the room-facing edges of the frame portions are relatively close together.

FIG. 1E shows how the same arrangement can easily adapt to fit a wider wall. The frame construction in FIG. 1E is unchanged compared to FIG. 1D; only the width of the wall 106 and resulting relative position of the frame portions has changed. This modification is possible because of the sliding engagement between the first frame portion 102 and the second frame portion 104. In particular, in order to adapt to a wider wall 106, the frame portions merely need to be slid apart, closer to the maximal separation defined by the first limit position.

This is shown in yet further detail by FIGS. 1F and 1G which show a single side of the first and second frame portions in cross section. FIG. 1F shows the second frame portion 104 slidingly received within the first frame portion 102 as described above. In this arrangement, the wall 106 is relatively thin (corresponding to FIG. 1D), so the frame portions are approaching the second limit position (minimal separation). In FIG. 1G, by contrast, the wall 106 is much thicker (corresponding to FIG. 1E), and so the frame portions are approaching the first limit position (maximal separation). Due to the sliding engagement, the frame portions can be quickly and easily moved to adapt to any wall thickness between the first and second limit positions. This means that prior knowledge of the thickness of the wall is unnecessary—the frame can simply be adapted to the wall at fitting time. Further, because the first and second frame portions are prefabricated to fit into one another, a good fit between the frame portions, with no gaps or misalignment, can be ensured. This can be achieved regardless of the skill or training level of the construction workers who actually fit the frame to the wall. Because the frame portions are prefabricated, there is also a reduced possibility for alignment errors (e.g. lack of square corners) due to human error.

As noted above, the disclosed door system is particularly advantageous when a door leaf is pre-hung in one of the frame portions. A door leaf may advantageously be hung in the second frame portion 104, for example. Again, this can be done at fabrication time such that when it comes to fitting the door system to the wall 106, the door leaf is already pre-hung in the second frame portion 104. The second frame portion 104, including the pre-hung door leaf, can then simply be slid into the first frame portion 102 in the manner described above. In other words, no additional step of hanging the door leaf is required. This ensures that the door leaf remains well fitted to the frame and reduces the likelihood of the door leaf or any anti-ligature devices comprised in the door leaf or door frame being damaged. This is very beneficial because anti-ligature devices such as ligature-detection sensors or anti-ligature hinges may easily become damaged or misaligned if the door is hung on-site during fitting. Damage or misalignment may create serious safety issues for patients or inmates, as described in the introduction above. By having the door pre-hung in the second frame portion 104 prior to fitting of the door system, such problems can be avoided, and patient safety can be improved.

A method for fitting the door systems of the present disclosure is shown schematically in FIG. 2. This method can be used to fit any of the door systems described herein. The method begins, at block 201, by securing a first frame portion 102 of the door system to a wall 106. This securing step and all other securing steps described in this disclosure can be performed using any suitable attaching means. The most typical means are fixing screws, bolts, welding, or adhesives, however other means will be apparent to a skilled reader. Next, at block 203, the first frame portion 102 is engaged with a second frame portion 104. In particular, as described above, second frame portion 104 can be received by or otherwise brought into sliding engagement with first frame portion 102. Due to the sliding nature of the engagement, the second frame portion 104 can then be moved (slid) as needed to abut the wall 106, at block 205. As described above, the second frame portion 104 can be moved to any position between the first and second limit positions of the frame, which respectively define the maximal and minimal separation of the room-facing edges or flanges of the frame portions. Once the second frame portion 104 has been brought into contact with the wall 106, the second frame portion 104 can be secured to the wall 106, at block 207. The second frame portion 104 can of course also be secured to the first frame portion 102 as needed.

As can be seen, the method of FIG. 2 provides a mechanism for the door system to fit any thickness of wall between the first and second limit positions of the frame. If a door leaf is pre-hung in the second frame portion 104 prior to performing the method of FIG. 2, then a good fit between the door leaf and frame can be ensured. Damage to the frame, door leaf or any anti-ligature devices comprised in the door or frame can also be avoided as noted above, because no separate step of hanging the door leaf (which is when most such damage occurs) is required. Fitting of the door system is thus made simpler, more reliable and patient safety is improved.

The frame portions shown in FIGS. 1A-1G are relatively simple in that they contain no additional elements or features beyond the basic frame structures themselves. The present inventors have identified that the frame portions can be made more useful through provision of one or more supporting elements. As noted above, doors for use in psychiatric wards and prisons are generally significantly heavier than doors used in domestic or office settings. As a result, the fixings holding these doors to the door frame need to be strong. The combination of a heavy door and strong, heavy-duty fixings means results in a significant amount of force and stress being exerted on the door frame portions. It is beneficial to avoid these forces from bending or warping the frame, because such bending could weaken the frame, making it less resilient to potential patient or inmate abuse. Bending or warping could also create a ligature risk if a crevice or anchor point is created as a result.

In view of this, the present disclosure provides one or more support elements which can be affixed to the first frame portion 102 and/or second frame portion 104 to provide greater rigidity. The support elements also provide additional contact points between the frame portions and the wall 106, which improves stability and provides additional points where packing or shims can be placed. This means the frame is not only more stable but can also be fitted more easily to uneven wall surfaces. Example support elements are shown in cross-section in FIGS. 3A and 3B. The support elements are shown affixed to first frame portion 102 in this example. It will be appreciated that the support elements can be affixed to the first frame portion 102 or the second frame portion 104 in any suitable manner. In one example, the support elements are laser-welded to the frame portions during fabrication of the frame portions. Other suitable attachment means that can be used, including screws, bolts, or adhesives, will be envisaged by a skilled reader.

A first example support element 301 is shown in FIG. 3A. This support element has an “open” construction, in the sense that the support element 301 does not form any closed cross-sectional area with respect to the frame portion 102 to which it is attached. While such a support element will provide some structural support to the frame portion 102, the present inventors have identified that open support elements are poorly optimised to resist the kinds of twisting and pulling forces exerted on the frame during fitting of door frames for use with anti-ligature doors. In particular, twisting forces (indicated by arrows 305) and pulling forces (indicated by arrow 307) are often exerted on the frame due to fixing means (e.g. screws) holding the frame portion 102 to the wall 106. The open support element 301 will only resist these forces to a limited extent.

Accordingly, the present inventors have identified that it is preferable to use “closed” support elements in frames that are designed to hold doors in settings such as psychiatric wards and prisons. An example of a closed support element 303 is shown in FIG. 3B. As can be seen, the support element 303 is closed in the sense that it creates a closed cross-sectional area with respect to frame portion 102 to which it is attached. The present inventors have identified that a closed structure is far better suited to withstand the kinds of twisting and pulling forces that are often created when fixing a door frame to a wall, particularly when the door is heavy. The example closed support element 303 has a substantially “u-shaped” structure, in that it has two substantially vertical supporting limbs configured to abut the first frame portion 102, and a substantially horizontal intermediate limb coupling the two supporting limbs. It will be appreciated that the terms “vertical” and “horizontal” are relative terms intended merely to aid understanding of the shape of the support element. In contrast to the open support element 301 of FIG. 3A, this closed structure provides two contact points between the frame portion 102 and the support element 303, improving rigidity and resistance to bending and twisting forces. Advantageously, support elements of the sort shown in FIG. 3B can be incorporated throughout the first and second frame portions of the present disclosure, as shown more clearly in FIGS. 4A-4L and 5A-5L.

Turning first to FIGS. 4A-4L, a number of views of a second example door system according to the present disclosure are shown. In this example the door system provides a bedroom door such as may be provided in a psychiatric ward. As mentioned above, the door leaf in such a system is likely to be heavy and robust, meaning that the disclosed systems are particularly suitable in terms of providing sufficient structural support to the frame holding such a door leaf.

As in FIGS. 1A-1G, the door system in this example comprises a first frame portion 402 and a second frame portion 404. These correspond to the first frame portion 102 and second frame portion 104 of FIGS. 1A-1G and have similar constructions and functions. In this example, a door leaf 406 is shown pre-hung in the second frame portion 404. Advantageously, the door leaf 406 in this example is free of ligature anchor points when it is closed, meaning that there are no hard edges, lips, ledges, crevices or protrusions into or around which a ligature could be fastened or anchored. In this example, the door leaf 406 comprises a viewing window. The window is flush with the face of the door leaf 406 to avoid providing any ledge or lip to which a ligature could be attached. The door leaf 406 also comprises and an anti-ligature handle. All surfaces of the handle may be substantially curved to prevent ligature attachment. The door leaf 406 is also fitted with a ligature-detection sensor (not shown) which is provided along the three accessible edges of the door leaf 406. Ligature-detection sensors are configured to identify when a ligature may be being tied or secured around the door leaf. In some contexts, such ligature-detection sensors may be referred to as ‘door alarms.’ A ligature in this context means a rope, cable, noose or other binding which may be used by a person to harm themselves, typically through asphyxiation, once secured to a door. It will be appreciated that any variety and combination of anti-ligature devices can be provided within the disclosed door systems.

The frame portions in this example comprise a plurality of support elements of the short shown in FIG. 3B. In particular, a set of first support elements 408 is shown, attached to the first frame portion 402. Each first support element 408 is configured to provide a contact point between the first frame portion 402 and a wall 106. Similarly, a set of second support elements 410 is provided, attached to the second frame portion. Each second support element 410 is configured to provide a contact point between the second frame portion 404 and the wall 106. Finally, a set of third support elements 412 is shown, attached to the second frame portion 404. Each third support element 412 is configured to provide a contact point between the first frame portion 402 and the second frame portion 404. It will be appreciated that any number (including none) and combination of first, second and third support elements can be provided in this example door system and all other door systems of this disclosure. Each support element improves the rigidity and stability of the frame once assembled and fixed to the wall. As noted above, the first and second support elements also provide additional contact points with the wall which makes packing and shimming easier in case of an uneven wall surface.

FIGS. 4A and 4B show the door system in its unassembled state, prior to installation. As noted, door leaf 406 is already pre-hung in second frame portion 404. The frame portions in this example are configured as in the case of FIGS. 1A-1G, in other words first frame portion 402 is configured to slidingly engage with second frame portion 404 such that the frame can adapt to a variety of wall widths between first and second limit positions of the frame portions. FIG. 4C shows the example door system from above in its assembled state, i.e. with second frame portion 404 slidingly engaged with first frame portion 402. The sets of first 408, second 410, and third 412 support elements provided on the respective frame portions are visible on all three edges of the frame portions.

FIG. 4D shows the assembled arrangement in perspective view. As shown in FIGS. 4A-4D the support elements 408, 410, 412 can be provided at intervals around the perimeter of each respective frame portion. The precise interval and spacing can of course be varied as required by different environments and contexts. Beneficially, the first support elements 408 on the first frame portion 402 can be positioned such that they correspond to the position(s) of corresponding second 410 and/or third 412 support elements provided on the second frame portion 404. This arrangement further improves stability because the synergy of the support provided by the respective support elements is enhanced.

FIG. 4E shows the assembled arrangement in top-down cross-section. FIGS. 4F-4H show the cross-sectional arrangement of FIG. 4E but now shown in context of a wall 106. As can be see, the frame portions can again adapt to a variety of wall thicknesses between the minimal and maximal separations defined by the first and second limit positions of the frame portions. FIG. 4F shows a thin wall 106, with the frame portions 402, 404 at or near the second limit position (minimal separation). FIG. 4G shows a slightly wider wall 106, with the frame portions 402, 404 moved further apart to accommodate this increased width. Finally, FIG. 4H shows the frame fitted to an even wider wall 106, with the frame portions 402, 404 now at or approaching the first limit position (maximal separation).

FIGS. 4I and 4J are cross-sectional views of one edge of the door frame, corresponding to FIGS. 1F and 1G, and show the frame portions 402, 404 near their minimal and maximal separation respectively. In this example, however, the effect of support elements 408, 410, 412 can be clearly seen. In particular, support element 408 provides rigidity and stability to the contact between first frame portion 402 and the wall 106. Analogously, support element 410 provides rigidity and stability to the contact between second frame portion 404 and the wall 106. Third support element 412 provides rigidity at the interface between the first frame portion 402 and the second frame portion 404. By comparing FIGS. 4I and 4J to FIGS. 1F and 1G, the impact of the support elements 408, 410, 412 can clearly be seen. In particular, the frame portions are much more securely supported in the arrangement of FIGS. 4I and 4J, and it is apparent that fixing of the frame portions together and/or to the wall 106 is likely to result in less bending and warping of the frame portions. There is also significantly more contact area in which packing, or shims can be provided to account for any unevenness in the wall 106.

Turning finally to FIGS. 4K and 4L, these figures show the support elements in exploded and assembled views. For clarity, the frame portions to which these support elements would in practice be attached are omitted. It can be seen from these figures and also FIGS. 4I and 4J that the support elements are configured to enable the required sliding engagement between the first frame portion 402 and second frame portion 404. In particular, the supporting elements are positioned and dimensioned such that they each provide their respective supporting roles regardless of whether the frame portions are at the first limit position, second limit position or somewhere in between.

Turning next to FIGS. 5A-5L, a number of views of a third example door system according to the present disclosure are shown. In this example the door system provides a shower door such as may be provided in a psychiatric ward. FIGS. 5A-5L correspond to FIGS. 4A-4L and corresponding reference numerals relate to corresponding features. In particular, first frame portion 502 and second frame portion 504 are provided. A door leaf 506 is hung in the second frame portion 504. A set of first support elements 508 is provided at intervals around the perimeter of the first frame portion 502. Sets of second support element 510 and third support element 512 are similarly provided at intervals around the perimeter of the second frame portion 504. These support elements have the same function described above in relation to FIGS. 4A-4L. The first frame portion 502 and second frame portion 504 can again slidingly engage between first and second limit positions to accommodate a variety of wall thicknesses.

The main difference between FIGS. 5A-5L and FIGS. 4A-4L is that the door leaf 506 is different. In this case, the door leaf 506 is an interior shower door. Because such a door may be provided within a patient's room, it is particularly important that no ligature can be attached to the door because the edges of the door leaf are always available, even in the closed state. Accordingly, door leaf 506 has a sloped top edge to prevent ligature attachment. This sloped edge is a form of anti-ligature device in that it makes it difficult to attach a ligature to the top edge of the door leaf 506. If pressure is applied to such a ligature, it will naturally slide down the door leaf 506 and come loose. A complimentary fin 514, most clearly shown in FIG. 5D, is provided on the second frame portion 504. The fin provides an abutment point for the closing edge of the door leaf 506. The fin 514 is made from a flexible material, so that it is difficult to attach a ligament to the fin 514 or to wedge a ligature between the fin 514 and the door leaf 506. An example of a flexible fin that can be used is provided in United Kingdom patent GB2564229 in the name of Kingsway Enterprises (UK) Limited, the disclosure of which is hereby incorporated in full.

All other features and functionality provided by the door system of FIGS. 5A-5L are substantially the same as in FIGS. 4A-4L. The example of FIGS. 5A-5L is thus primarily included to show that the door system is constructed and functions in substantially the same way regardless of the type of door being provided. This is beneficial because production of the door system can be easily adapted to suit a variety of door types, and the fitting process that needs to be performed by end-users (e.g. construction workers) does not change regardless of the type of door being provided.

FIGS. 4A-4L and FIGS. 5A-5L provide example door systems having particular types of door leaf and particular accompanying anti-ligature devices. It will be appreciated, however, that any suitable door construction can be used and provided within the door systems of the present disclosure. Similarly, any combination of anti-ligature devices can be provided. Some example anti-ligature devices which can be used are described more fully below, however it is to be appreciated that this is not an exhaustive list and other anti-ligature devices will be apparent to the skilled reader. In its most general form, an anti-ligature device can be considered as a device that is configured to prevent attachment of a ligature and/or to facilitate detection of a ligature that has been attached.

A variety of ligature-detection sensors are available and can be used as anti-ligature devices in the context of the present disclosure. For example, United Kingdom patents GB2589113 and GB2590483, both in the name of Kingsway Enterprises (UK) Limited, disclose example ligature-detection sensors which use ribbon switches to detect pressure applied by a potential ligature secured to a door leaf. The disclosures of these references are hereby incorporated in full. Similarly, United Kingdom patent GB2596922, also in the name of Kingsway Enterprises (UK) Limited, discloses an inductive ligature-detection sensor which uses inductance to detect a potential ligature. The disclosure of this reference is also hereby incorporated in full. Other examples of ligature-detection sensors may be known to the skilled person and can be used in the systems and methods of the present disclosure. The systems and methods of the present disclosure are particularly advantageous when doors are fitted with ligature-detection sensors, for the reasons outlined above. In particular, a precise fitting of the door leaf within the door frame is particularly important to ensure proper functioning of ligature-detection sensors. If the door is poorly fitted, then the gap between the door and frame may be too small or too large. In either case, correct functioning of the ligature-detection sensor can be hindered, which can put patient safety at risk.

An example ligature-detection sensor is shown in FIG. 6. Ligature-detection sensor 602 is in this case placed along an edge of a door leaf, for example door leaf 406 shown previously in FIGS. 4A-4L. In this example ligature-detection sensor 602 is an inductive ligature-detection sensor which uses inductance to detect a potential ligature. Ligature-detection sensors of this type are described more fully in GB2596922, as noted above. FIGS. 7A-7C show example arrangements of ligature-detection sensors, such as that shown in FIG. 6. Each door system shown in FIGS. 7A-7C includes a door leaf, for example door leaf 406 shown previously in FIGS. 4A-4L. Each door leaf 406 is pivotally attached to a door frame portion, in this case second frame portion 404 described above with reference to FIGS. 4A-4L. For simplicity, only part of the second door frame portion 404 is shown in each figure, namely the edge of the frame that is connected to the door leaf 406 by a hinge. In the door system of FIG. 7A, a ligature-detection sensor 602 is attached to a top edge of the door leaf 406. The ligature-detection sensor 602 is represented by a thick black line along the top edge of the door leaf 406. In the door system of FIG. 7B, ligature-detection sensors 602 are attached to a top edge of the door leaf and a closing edge of the door leaf 406. In the door system of FIG. 7C ligature-detection sensors 602 are attached to a top edge of the door leaf 406, a closing edge of the door leaf 406, and a bottom edge of the door leaf 406. Other arrangements are possible, as will be apparent to a skilled reader.

Other examples of anti-ligature devices which may be incorporated into the systems of the present disclosure will be apparent to the skilled reader. Some examples are provided below, all of which are suitable for use with the systems and methods of the present disclosure. Suitable anti-ligature door handles are disclosed in United Kingdom design registrations GB6073262 and GB90022888860001, both in the name of Kingsway Enterprises (UK) Limited. Suitable anti-ligature door hinges are disclosed in United Kingdom patents GB2562483, GB2585942 and GB2555780, all in the name of Kingsway Enterprises (UK) Limited. A suitable anti-ligature door having a sloped top edge is described in further detail in United Kingdom patent GB2564229, in the name of Kingsway Enterprises (UK) Limited. As noted above, a suitable anti-ligature fin made from a flexible material is also disclosed in United Kingdom patent GB2564229, in the name of Kingsway Enterprises (UK) Limited. Finally, anti-ligature door locks are disclosed in United Kingdom patent GB2583977 and United Kingdom patent application GB2606214. The disclosures of each of these references is hereby incorporated in full.

Regardless of the particular combination of anti-ligature devices, the disclosed systems and methods provide significant benefits in that proper fitting of a door leaf within a door frame can be assured. This ensures proper functioning of the anti-ligature devices. Because a door leaf can be pre-hung in the second frame portion, no separate hanging step is required during fitting. Also, the frame portions can easily engage with one another in a sliding manner, making fitting of the frame to the wall simple. The simplification of the fitting process means there is less likelihood of the door leaf, frame or any anti-ligature devices comprised therein becoming misaligned or damaged. As a result, assembly and installation is simplified and patient safety is improved.

The above detailed description describes a variety of arrangements and methods relating to fitting of door systems. However, the described arrangements and methods are merely exemplary, and it will be appreciated by a person skilled in the art that various modifications can be made without departing from the scope of the appended claims. For example, it will be appreciated that all door frame and door leaf shapes and relative dimensions shown and described in the above implementations are merely examples. The disclosed systems and methods are adaptable and suitable for use with any shape or type of door leaf and door frame. Other modifications will be apparent to a person skilled in the art. Further, components and method steps may be combined in any suitable arrangement or combination. Components and method steps may also be omitted to leave any suitable combination of components or method steps.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features but does not exclude the inclusion of one or more further features.

The above implementations have been described by way of example only, and the described implementations are to be considered in all respects only as illustrative and not restrictive. It will be appreciated that variations of the described implementations may be made without departing from the scope of the disclosure. It will also be apparent that there are many variations that have not been described, but that fall within the scope of the appended claims.

Features described above as well as those claimed below may be combined in various ways without departing from the scope hereof. The following examples illustrate some possible, non-limiting combinations:

(A1) A door system for fitting to a wall, the door system comprising: a first frame portion; and a second frame portion to which a door leaf is attached, wherein the door leaf comprises an anti-ligature device, wherein the second frame portion is configured to slidingly engage with the first frame portion between first and second limit positions such that the door system can accommodate a variety of wall thicknesses.

(A2) For the door system denoted as (A1), wherein the anti-ligature device comprises at least one of: a ligature-detection sensor; an anti-ligature hinge; an anti-ligature door handle; and a sloped door leaf edge.

(A3) For the door system denoted as (A1) or (A2), wherein the anti-ligature device comprises a sloped door leaf edge, and wherein the sloped door leaf edge is the top edge of the door leaf.

(A4) For the door system denoted as (A1) through (A3), wherein the anti-ligature device comprises an anti-ligature door handle, and wherein the anti-ligature door handle has a continuously sloped profile that is free of ligature anchor points.

(A5) For the door system denoted as (A1) through (A4), wherein the first frame portion comprises a first support element configured to provide a contact point between the first frame portion and a wall.

(A6) For the door system denoted as (A1) through (A5), wherein the first support element defines a closed cross-sectional area with respect to the first frame portion.

(A7) For the door system denoted as (A1) through (A6), wherein the first support element comprises two supporting limbs configured to abut the first frame portion, and an intermediate limb coupling the two supporting limbs.

(A8) For the door system denoted as (A1) through (A7), wherein the second frame portion comprises a second support element configured to provide a contact point between the second frame portion and a wall.

(A9) For the door system denoted as (A1) through (A8), wherein the second support element defines a closed cross-sectional area with respect to the second frame portion.

(A10) For the door system denoted as (A1) through (A9), wherein the second frame portion comprises a third support element configured to provide a contact point between the first frame portion and the second frame portion.

(A11) For the door system denoted as (A1) through (A10), wherein the third support element defines a closed cross-sectional area with respect to the second frame portion.

(A12) For the door system denoted as (A1) through (A11), wherein at least one of the second or third support elements comprises two supporting limbs configured to abut the second frame portion, and an intermediate limb coupling the two supporting limbs.

(A13) For the door system denoted as (A1) through (A12), wherein the door leaf, when in the closed position, is free of ligature anchor points.

(A14) For the door system denoted as (A1) through (A13), wherein the second frame portion comprises a fin configured to contact the door leaf when the door leaf is in the closed position, wherein the fin is made from a flexible material.

(B1) A method of fitting a door system to a wall, comprising: securing a first frame portion to a wall; engaging the first frame portion with a second frame portion, wherein a door leaf comprising an anti-ligature device is attached to the second frame portion and wherein the second frame portion is configured to slidingly engage with the first frame portion between first and second limit positions; moving the second frame portion to a position between the first and second limit positions such that the first and second frame portions abut respective faces of the wall; and securing the second frame portion to the wall.

(B2) For the method denoted as (B1), wherein the anti-ligature device comprises at least one of: a ligature-detection sensor; an anti-ligature hinge; an anti-ligature door handle; and a sloped door leaf edge.

(B3) For the method denoted as (B1) or (B2), wherein the anti-ligature device comprises a sloped door leaf edge, and wherein the sloped door leaf edge is the top edge of the door leaf.

(B4) For the method denoted as (B1) through (B3), wherein the anti-ligature device comprises an anti-ligature door handle, and wherein the anti-ligature door handle has a continuously sloped profile that is free of ligature anchor points.

(B5) For the method denoted as (B1) through (B4), wherein the door leaf, when in the closed position, is free of ligature anchor points.

(B6) For the method denoted as (B1) through (B5), wherein the second frame portion comprises a fin configured to contact the door leaf when the door leaf is in the closed position, wherein the fin is made from a flexible material.

(B7) For the method denoted as (B1) through (B6), wherein the first support element defines a closed cross-sectional area with respect to the first frame portion.

(B8) For the method denoted as (B1) through (B7), wherein at least one of the first, second, or third support elements comprises two supporting limbs configured to abut the second frame portion, and an intermediate limb coupling the two supporting limbs.

(B9) For the method denoted as (B1) through (B8), wherein at least one of the second support element and the third support element defines a closed cross-sectional area with respect to the second frame portion.

(C1) A door system for fitting to a wall, the door system comprising: a first frame portion, wherein the first frame portion comprises a first support element configured to provide a contact point between the first frame portion and a wall; and a second frame portion, wherein the second frame portion comprises: a second support element configured to provide a contact point between the second frame portion and a wall; and a third support element configured to provide a contact point between the first frame portion and the second frame portion, wherein the second frame portion is configured to slidingly engage with the first frame portion between first and second limit positions such that the door system can accommodate a variety of wall thicknesses.

(C2) For the door system denoted as (C1), wherein the first support element defines a closed cross-sectional area with respect to the first frame portion.

(C3) For the door system denoted as (C1) or (C2), wherein at least one of the first, second, or third support elements comprises two supporting limbs configured to abut the second frame portion, and an intermediate limb coupling the two supporting limbs.

(C4) For the door system denoted as (C1) through (C3), wherein at least one of the second support element and the third support element defines a closed cross-sectional area with respect to the second frame portion.

(D1) A method of fitting a door system to a wall, comprising: securing a first frame portion to a wall, wherein the first frame portion comprises a first support element configured to provide a contact point between the first frame portion and the wall; engaging the first frame portion with a second frame portion, wherein the second frame portion is configured to slidingly engage with the first frame portion between first and second limit positions, and wherein the second frame portion comprises: a second support element configured to provide a contact point between the second frame portion and the wall; and a third support element configured to provide a contact point between the first frame portion and the second frame portion; moving the second frame portion to a position between the first and second limit positions such that the first and second frame portions abut respective faces of the wall; and securing the second frame portion to the wall.

(D2) For the method denoted as (D1), wherein the first support element defines a closed cross-sectional area with respect to the first frame portion.

(D3) For the method denoted as (D1) or (D2), wherein at least one of the first, second, or third support elements comprises two supporting limbs configured to abut the second frame portion, and an intermediate limb coupling the two supporting limbs.

(D4) For the method denoted as (D1) through (D3), wherein at least one of the second support element and the third support element defines a closed cross-sectional area with respect to the second frame portion.

1. A door system for fitting to a wall, the door system comprising:
a first frame portion; and
a second frame portion to which a door leaf is attached, wherein the door leaf comprises an anti-ligature device,
wherein the second frame portion is configured to slidingly engage with the first frame portion between first and second limit positions such that the door system can accommodate a variety of wall thicknesses.

2. The door system of claim 1, wherein the anti-ligature device comprises at least one of:
a ligature-detection sensor;
an anti-ligature hinge;
an anti-ligature door handle; or
a sloped door leaf edge.

3. The door system of claim 2, wherein the anti-ligature device comprises the sloped door leaf edge, and wherein the sloped door leaf edge is a top edge of the door leaf.

4. The door system of claim 2, wherein the anti-ligature device comprises the anti-ligature door handle, and wherein the anti-ligature door handle has a continuously sloped profile that is free of ligature anchor points.

5. The door system of claim 1, wherein the first frame portion comprises a first support element configured to provide a contact point between the first frame portion and the wall.

6. The door system of claim 5, wherein the first support element defines a closed cross-sectional area with respect to the first frame portion.

7. The door system of claim 5, wherein the first support element comprises two supporting limbs configured to abut the first frame portion, and an intermediate limb coupling the two supporting limbs.

8. The door system of claim 1, wherein the second frame portion comprises a second support element configured to provide a contact point between the second frame portion and the wall.

9. The door system of claim 8, wherein the second support element defines a closed cross-sectional area with respect to the second frame portion.

10. The door system of claim 9, wherein the second frame portion comprises a third support element configured to provide a further contact point between the first frame portion and the second frame portion.

11. The door system of claim 10, wherein the third support element defines a further closed cross-sectional area with respect to the second frame portion.

12. The door system of claim 11, wherein at least one of the second support element or the third support element comprises two supporting limbs configured to abut the second frame portion, and an intermediate limb coupling the two supporting limbs.

13. The door system of claim 1, wherein the door leaf, when in a closed position, is free of ligature anchor points.

14. The door system of claim 1, wherein the second frame portion comprises a fin configured to contact the door leaf when the door leaf is in a closed position, wherein the fin is made from a flexible material.

15. A method of fitting a door system to a wall, comprising:
securing a first frame portion to the wall;
engaging the first frame portion with a second frame portion, wherein a door leaf comprising an anti-ligature device is attached to the second frame portion and wherein the second frame portion is configured to slidingly engage with the first frame portion between first and second limit positions;
moving the second frame portion to a position between the first and second limit positions such that the first frame portion and the second frame portion abut respective faces of the wall; and
securing the second frame portion to the wall.

16. The method of claim 15, wherein the anti-ligature device comprises at least one of:
a ligature-detection sensor;
an anti-ligature hinge;
an anti-ligature door handle; or
a sloped door leaf edge.

17. The method of claim 15, wherein the door leaf, when in a closed position, is free of ligature anchor points.

18. The method of claim 15, wherein the second frame portion comprises a fin configured to contact the door leaf when the door leaf is in a closed position, wherein the fin is made from a flexible material.

19. A door system for fitting to a wall, the door system comprising:
a first frame portion, wherein the first frame portion comprises a first support element configured to provide a first contact point between the first frame portion and the wall; and
a second frame portion, wherein the second frame portion comprises:
a second support element configured to provide a second contact point between the second frame portion and the wall; and
a third support element configured to provide a third contact point between the first frame portion and the second frame portion,
wherein the second frame portion is configured to slidingly engage with the first frame portion between first and second limit positions such that the door system can accommodate a variety of wall thicknesses.

20. A method of fitting a door system to a wall, comprising:
securing a first frame portion to the wall, wherein the first frame portion comprises a first support element configured to provide a first contact point between the first frame portion and the wall;
engaging the first frame portion with a second frame portion, wherein the second frame portion is configured to slidingly engage with the first frame portion between first and second limit positions, and wherein the second frame portion comprises:
a second support element configured to provide a second contact point between the second frame portion and the wall; and
a third support element configured to provide a third contact point between the first frame portion and the second frame portion;
moving the second frame portion to a position between the first and second limit positions such that the first frame portion and the second frame portion abut respective faces of the wall; and
securing the second frame portion to the wall.
